(19) United States
(12) Patent Application Publication
(10) Pub. No.: US 2010/0083809 A1
(43) Pub. Date: Apr. 8, 2010

(54) V-pick guitar pick

(76) Inventor: Vincent Lane Smith, Modesto, CA (US)

Correspondence Address: Vincent Lane Smith, 1633 Oakwood Dr., Modesto, CA, 95350, US

(21) Appl. No.: 12/286,818

(22) Filed: Oct. 3, 2008

(51) Int. Cl. G10D 3/16

(52) U.S. Cl. 84/322

(57) ABSTRACT

The V-Pick Guitar Pick is a new kind of plectrum used for guitars, mandolins, bass guitars, and all stringed instruments requiring a pick or plectrum. It utilizes a new acrylic plastic that allows for a reliable grip, pure tone, and the ability to strum across the strings quickly and efficiently. Through creating a thicker pick, V-Picks has found a way that allows artists and beginners with arthritis to enjoy a comfortable way of playing their string instrument. The ability of an artist to achieve pure tone and quality range on their instrument is attained through the use of V-Pick Guitar Picks. Therefore, the ability for background sound obstructions to be eliminated dramatically increases. Hence artists can record the pure tone that the desire to express through music.

V-Pick International entrepreneur family business as associated with RBK Tool and Dye, pending application of utility patent for the 2008 V-Pick Guitar Picks and the use there of for their injection moldable acrylic plastic for the creation of guitar picks. V-Picks is an independent company planning upon the transition to corporation via October 2008. V-Picks is based in the Smith residence at 1633 Oakwood Dr. in Modesto, Calif.; postal zip code 95350. As such with the conversation, the family owned and operated company shall apply for the utility patent of using the injection moldable acrylic plastic with the mutual consent of RBK Tool and Dye for the use of guitar picks. It is the with the full and mutual cooperation and consideration of RBK Tool and Dye, that V-Picks International takes the full right and credit for the use of the their injection moldable acrylic plastic resin for guitar picks.

Vincent Lane Smith first conceived this idea for the use of the injection moldable acrylic plastic for his custom guitar picks on Oct. 5, 2007. He has hence used the injection moldable acrylic plastic at the RBK Tool and Dye store in Modesto, Calif. for all of his pick production. RBK Tool and Dye has held and used this injection moldable acrylic for V-Picks, as well as the injection mold for all V-Picks as designed by Vincent Lane Smith.

The V-Pick Guitar Pick is the original design of Vincent Lane Smith. As such the utility patent shall also protect the rights of Vincent Smith and V-Picks to be the soul-users of the rifts of the pick design, which is a resultant of the V-Pick injection molds.

### CROSS-REFERENCE RELATED TO APPLICATION

No prior applications exist nor are pending for any product, utility or application of V-Picks International. Neither do any prior applications of a patent exist for Vincent Lane Smith or the Smith family with or without correlation to V-Picks International. This present patent application is the first filed application for the V-Pick Guitar Pick and the use of injection moldable acrylic plastic for guitar picks.

### STATEMENT REGARDING FEDERALLY SPONSORED RESEARCH OR DEVELOPMENT

The V-Pick Guitar Pick has not undergone any federal sponsorship, research, or development. As such, neither has the injection moldable plastic used in the V-Pick Guitar Picks.

### REFERENCE TO SEQUENCE LISTING, A TABLE, OR A COMPUTER PROGRAM LISTING

Not Applicable

### COMPACT DISC APPENDIX

No sequence listings, tables, or computer program listing support the V-Pick Guitar Pick or the injection moldable acrylic plastic nor the patents for this application.

### BACKGROUND OF THE INVENTION

The V-Pick Guitar Pick was invented by Vincent Lane Smith, who first conceived the idea of the V-Pick in the year 1985. During his beginning years, he made the V-Pick prototype by hand. The production on this project was postponed due to the finical and family circumstances of the Smith family. It was not until the year 2005, that the project was resumed and Vincent Smith began working on a new material to use and a new way to produce the V-Pick.

Over the course of the next two years he researched different materials and decided on a clear cast acrylic; which is now provided by RBK Tool and Dye Store. During the course of those two years he also researched and experimented with the thickness of the pick; deciding on 2.75 millimeters. Through researching and communicating with different buyers, Vincent Lane Smith chose to purchase bulk sheets for production. Through experimenting with different shapes for the pick he chose a symmetrical three corner pick style. When it came time to choose the corners and bevel for this unique guitar pick, Vincent spent most of his effort and time in hand crafting the V-Pick. Upon which he determined to round the corners for better performance and precisely for the purpose of an improved mid-range. After using several kinds of clear acrylic plastic for the V-Pick, Vincent Lane Smith decided on two specific kinds for the sound effects of the pick, the ability of the plastics to warm up and hold onto the fingers of the player, and the general feel of the plastic. Through his efforts as previously listed Vincent Lane Smith made the first original V-Pick on Oct. 5, 2007. A second model of V-Pick has been created via Jan. 1, 2008.

In 2005, the realization that production would need to be drastically increased caused Vincent Lane Smith chose the plastic injection company help accelerate the process. The third company he investigated was RBK Tool and Dye, whom he selected for their injection moldable acrylic plastic facility. Once they joined efforts it was up to Vincent Lane Smith to choose the perfect bevel to make the picks with. Carefully and strategically determined the perfect bevel and the exact acrylic to use; due to the fact that different acrylics have different characteristics. The acrylic was chosen due to the feel, warmth, and resultant tone. Vincent Lane Smith then enclosed the dimensions and specks of the perfect V-Pick to RBK Tool and Dye, who then made a duplicate pick and the injection mold.

The process of the plastic being molded into pick form for the V-Pick is a relatively simple. The acrylic plastic is in a pellet form and feed into the molder. The plastic is heated to a workable temperature to liquefy the material. It is then injected into the V-Pick mold and cooled with water.

The V-Picks are then sent from the RBK Tool and Dye store back to the Smith family residence. There it is buffed and the shaved to the perfect shape and type of pick by the Smith family. Finally the picks are mailed to the different destinations of V-Pick buyers around the world.

Since October 2007, Vincent Lane Smith has been creating the V-Pick and selling it from his website at www.v-picks.com. He has also been distributing to store and other pick producers at guitar conventions and in every town that the Smith family visits. His son Adam Lane Smith is the production and public relations manager, and handles the buyers of V-Picks and finalizes the production of each individual pick. Vincent's wife, Nancy Lane Smith, is secretary and handles all finical work for the company. Their daughter, Audrey Lane Smith, is the assistant productions manager. All other persons in the Smith family have observed Vincent Lane Smith's process in designing and creating the V-Pick from the injection moldable acrylic plastic.

### BRIEF SUMMARY OF THE INVENTION

Through the development, there were no complications in the design or use of the V-Pick. The V-Pick itself was invented for the troubles that were and are present in manufactured guitar picks. The V-Pick is made out of this injection moldable acrylic due to its durability and the padding it provides for the guitar players hands; preventing pain and allowing even those with arthritis to play. The clear cast injection moldable acrylic conducts the warmth from the players body heat. Therefore allowing the pick to cling to the fingers of the player without slipping as the guitar is played. The results of the results of the V-Pick on guitar strings is pure quality sound, without any pick interference with the range or tones. Due to the shape of the bevel, the V-Pick gives an even clearer sound than other acrylic guitar picks.

### BRIEF DESCRIPTION OF THE SEVERAL VIEWS OF THE DRAWING

The dimensions and design of the basic V-Pick are as follows:

FIG. 1A displays the width and length of all regions of the pick as viewed from an anterior position on a coronal plane;

FIG. 1B displays the thickness of the pick and the sides as centered on the pick from a superior horizontal plane;

FIG. 2A depicts the bevel and curvature of the V-Pick distal from the center of the pick in a sagittal plane;

FIG. 2B is a view of the angle of the cut edges of the pick from an anterior position on the coronal plane.

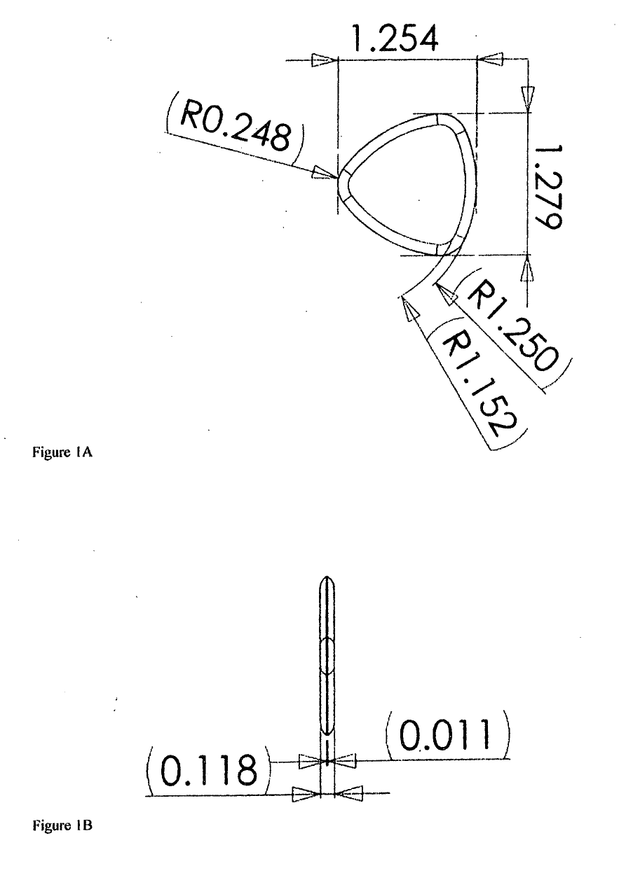

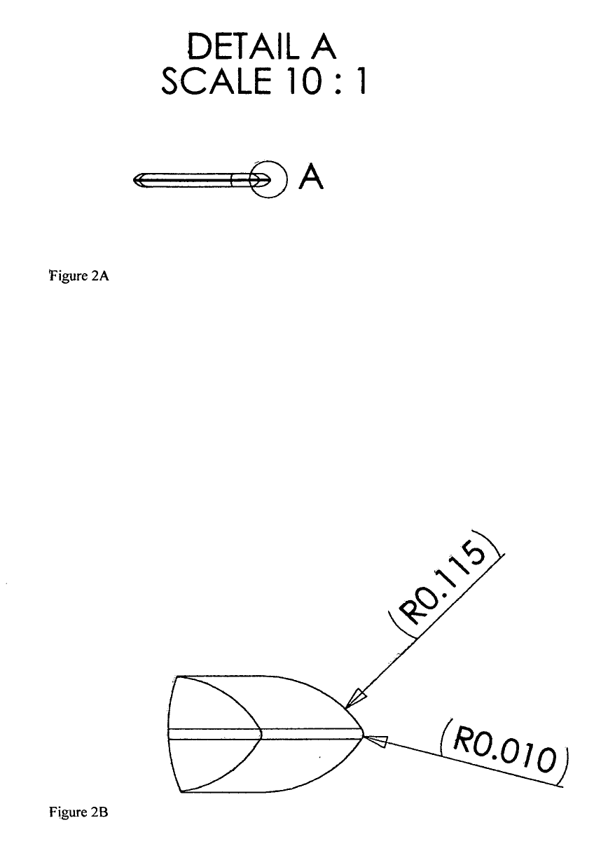

### DETAILED DESCRIPTION OF THE INVENTION

The V-Pick is a new style of hand crafted guitar pick made from a unique kind of clear injection moldable acrylic plastic. The pick is made out of this plastic for the physical properties and characteristics that the plastic exhibit. The plastics internal temperature increases due to conduction from contact with the hands of the holder. As the internal temperature increases the plastic itself holds to the hand of the holder without slipping out of grip. Due to the thick nature of V-Picks there is low resistance and stress exhibited between the fingers of the holder; aiding those with arthritis to play without complications. Overall tone created by the clear injection moldable acrylic plastic is pure tone without any interference from the pick or the player. V-Picks angel of bevel allows the pick to travel in fast and smooth motion over the strings; giving quality rhythm and sound.

1. The invention and process under the protection of this utility patent, issued Sep. 19, 2008, will encompass the following: the invention V-Pick Guitar Picks as created and designed by Vincent Lane Smith; all designs and models of V-Picks past, current, and pending; the ownership of V-Picks International by Vincent Lane Smith; the operations of V-Picks International by Vincent Lane Smith, Nancy Lane Smith, Adam Lane Smith, Audrey Lane Smith, and any other personal chosen by Vincent Lane Smith in further V-Picks procedures and manufacturing; and the use of the clear injection moldable acrylic plastic used to fabricate the V-Picks. V-Picks Guitar Picks are therefore and hereby recognized as a useable product originally conceived and made by Vincent Lane Smith. The fabrication of and/or manufacture of any pick using the V-Pick logo and/or the clear injection moldable acrylic plastic that constitute the V-Picks without the written contracted permission and overseeing of Vincent Lane Smith shall result in violation and obstruction of justice under penalty of fraud and perjury. Under no circumstances shall V-Picks International as a family owned and run company allow other competitor pick manufacturers access to the bevel, thickness, material, pick angels, or logo as used to create V-Picks. Violation of this claim shall result in V-Picks International bringing the offenders to justice and issuing a prompt lawsuit for the perjury of the product V-Picks. Any pick manufacturing who attempts to use the same clear injection moldable acrylic plastic for fabrication shall also have violated this patent; and will have hence illegally replicated a product material under the protection of this patent. Resulting in perjury and dealt with by a lawsuit for the replication of a protected idea and fabric. Any pick manufacturer who duplicates the bevel, thickness, or angel of the V-Pick is subject to perjury. This patent shall protect the bevel, thickness, and angels of the V-Pick. All parts of this patent are relevant to the protection of the following: the concept, creation, producing, manufacturing, materials, parts, and ownership of V-Picks International.
